(19) United States
(12) Patent Application Publication
(10) Pub. No.: US 2009/0117233 A1
(43) Pub. Date: May 7, 2009

(54) Corn salsa

(76) Inventor: Kathleen Sussman, Harrison, NY (US)

Correspondence Address: WEISS & WEISS, Suite 251, 300 Old Country Road, Mineola, NY, 11501, US

(21) Appl. No.: 12/290,710

(22) Filed: Nov. 3, 2008

Related U.S. Application Data
(60) Provisional application No. 61/001,620, filed on Nov. 2, 2007.

(51) Int. Cl. A23L 1/212; A23L 1/221; A23L 1/48

(52) U.S. Cl. 426/93

(57) ABSTRACT

A salsa comprising: corn; black beans; olive oil; cilantro; garlic and lime juice.

### RELATED APPLICATIONS

The present application is based on provisional application Ser. No. 61/001,620 filed Nov. 2, 2008.

### FIELD OF THE INVENTION

The present invention relates to a corn salsa.

### BACKGROUND OF THE INVENTION

Salsa is a food eaten with corn chips and other Mexican food. Salsa is typically prepared by cutting up tomatoes, onion greens, and other fresh vegetables. Salsa is commonly enjoyed in a variety of foods wherein it is mixed with sour cream, guacamole, ground beef, nacho chips and more. Salsa has a tomato base, and incorporates a variety of diced vegetables, all mixed together and then spiced in varying levels from mild to hot. The level of spiciness is usually derived from the pepper content.

US Patent Publication No. 2003/0003199 relates to a method and apparatus for producing salsa utilizing tomatoes in combination with a condiment mixture. The condiment mixture is dry and is sealed in a package prior to use. The dry condiment mixture includes chili pepper, dry garlic, sea salt, oregano leaves, and cumin seeds. The salsa can be used as a decongestant.

US patent publication No. 2003/0134026 relates to a homozygous rin and/or nor tomatoes, or tomatoes heterozygous in both rin and nor are used to prepare a tomato paste, juice or sauce having good viscosity as well as good color.

U.S. Pat. No. 5,914,146 relates method of preparing a salsa product. The salsa formulation comprises a tomato component, a whole pepper component, a whole spice component, and a powdered spice component. The whole pepper component comprises raw banana peppers, Serrano peppers, and jalapeno peppers which are boiled until soft and light green in color to release spicy oils contained in the pepper seeds that are not normally released when the peppers are ingested raw. The boiled peppers are de-stemmed and mixed with the tomato component, whole spice component, and powdered spice component, and then blended at high speed until a paste consistency is reached.

U.S. Patent Publication No. 2007/0141229 relates to a homestyle blend salsa which includes tomato, tomato paste, yellow onions, green onions, bell pepper, garlic salt, seasoned salt, black pepper, lemon juice, parsley, cilantro, Serrano pepper, jalapeno pepper, and habenero pepper.

### SUMMARY OF THE INVENTION

The present invention relates to a corn salsa. The present invention relates to a salsa comprising: corn, black beans, olive oil, cilantro, garlic, and lime. It is an object of the present invention for the salsa to further comprise salt. It is an object of the present invention for the salsa to further comprise pepper.

The present invention relates to a method of preparing a corn salsa comprising steaming corn on the cob for approximately 15 minutes and scraping the corn off the cob and into a bowl. Black beans, olive oil, cilantro, garlic and lime are all added to the corn and mix thoroughly until the salsa has a thorough consistency. A thorough consistency is defined as the contents being equally separated into the mixture.

It is an object of the present invention to produce a salsa having a specific texture.

It is an object of the present invention for the salsa to be frozen, and then defrosted for serving.

### DETAILED DESCRIPTION OF THE INVENTION

The present invention relates to a salsa comprising approximately 1½ cups of corn which is approximately 4 cobs. The salsa further comprises approximately 1⅓ cups of black beans, approximately ¼ cup of olive oil. In a preferred environment the olive oil is extra virgin olive oil. The salsa further comprises ¼ cup of chopped cilantro. The salsa further comprises 1 clove of garlic. In a preferred environment the garlic is mashed. The salsa further comprises approximately ¼ wedge of lime juice. In a preferred environment salt is added based on the taste of the user. In a preferred environment approximately ½ teaspoon of salt is added, preferably kosher salt. In a preferred environment, approximately ¼ teaspoon of pepper is added to the salsa.

1. A salsa comprising:
corn;
black beans;
olive oil;
cilantro;
garlic and lime juice.

2. The salsa of claim 1 further comprising salt.

3. The salsa of claim 1 further comprising pepper.

4. The salsa of claim 1 wherein said corn is cooked corn.

5. The salsa of claim 1 wherein said olive oil is extra virgin olive oil.

6. The salsa of claim 1 wherein said garlic is mashed.

7. A salsa comprising:
approximately 1½ cups of cooked corn;
approximately 1⅓ cups of black beans;
approximately ¼ cup of extra virgin olive oil;
approximately ¼ cup of chopped cilantro;
approximately 1 clove of garlic;
approximately ¼ wedge of lime juice.

8. The salsa of claim 7 further comprising:
approximately ½ teaspoon of salt.

9. The salsa of claim 7 further comprising:
approximately ¼ teaspoon of pepper.

10. A method for preparing corn salsa, steaming corn on the cob for approximately 15 minutes and scraping said corn off of said cob and placing said scraped corn into a bowl;
adding black beans, olive oil, cilantro, garlic and lime into said corn mixture;
mixing the contents of said bowl until it has a thorough consistency.

11. The method of claim 10 further comprising freezing said mixture.

12. The method of claim 11 further comprising defrosting said mixture.

13. The method of claim 10 further comprising mashing said garlic prior to adding said garlic to said mixture.

14. The method of claim 10 further comprising adding salt and pepper to said mixture.
